(19) United States
(12) Patent Application Publication
(10) Pub. No.: US 2026/0009698 A1
(43) Pub. Date: Jan. 8, 2026

(54) METHODS AND APPARATUS FOR LATERAL VEHICLE MOTION IN CHASSIS DYNAMOMETER

(71) Applicants: Abdel Ra'ouf Mayyas, Gilbert, AZ (US); Mohsen Sheibanian, Tempe, AZ (US)

(72) Inventors: Abdel Ra'ouf Mayyas, Gilbert, AZ (US); Mohsen Sheibanian, Tempe, AZ (US)

(21) Appl. No.: 19/326,455

(22) Filed: Sep. 11, 2025

Related U.S. Application Data
(63) Continuation-in-part of application No. 19/098,434, filed on Apr. 2, 2025.
(60) Provisional application No. 63/573,831, filed on Apr. 3, 2024.

(51) Int. Cl. G01M 17/007; G01M 17/06

(52) U.S. Cl. CPC G01M 17/0074; G01M 17/065

(57) ABSTRACT

A dynamometer system may comprise motorized rollers disposed on motorized rotational mounts such that the dynamometer may simulate lateral motion as well as longitudinal motion of a vehicle under test. A dynamometer system may comprise at least one roller for supporting a vehicle tire. The roller may be supported by a turn table. The roller and the turn table may be coupled to direct-drive rotational motors. The roller and the turn table may be configured to rotate about perpendicular axis. The dynamometer may be operated in a variety of modes which may allow for at least one of or combinations of evaluation of lateral dynamics, longitudinal dynamics, or vertical dynamics of a vehicle under test. In this manner, more realistic evaluation of vehicle performance can be obtained in a controlled environment.

### CROSS-REFERENCE TO RELATED APPLICATIONS

This application is continuation in part and claims priority to U.S. Non-Provisional patent application Ser. No. 19/098,434 filed Apr. 2, 2025, entitled “Methods and Apparatus for Lateral Vehicle Motion in Chassis Dynamometer”, which claims priority to, and the benefit of U.S. Provisional Patent Application No. 63/573,831 filed on Apr. 3, 2024, entitled “Methods and Apparatus for Lateral Vehicle Motion in Chassis Dynamometer.” The disclosure of the foregoing applications are incorporated herein by reference (except for any subject matter disclaimers or disavowals, and except to the extent of any conflict with the disclosure of the present application, in which case the disclosure of the present application shall control).

### TECHNICAL FIELD

The present disclosure relates to vehicle performance testing, and particularly to vehicle performance testing and evaluating via dynamometer.

### BACKGROUND

Dynamometers are used to measure, test, and evaluate the force, torque, power, etc. of vehicles by simultaneously measuring torque and rotational speed. For example, chassis dynamometers use rollers and motors to simulate road and vehicle conditions within a controlled environment. Conventional dynamometers are configured to simulate motion in a single axis, typically a longitudinal axis. Single axis motion simulation can limit testing and evaluation of the maneuverability automated (AV) or connected and automated (CAV) vehicles, which may operate with reduced or no human operation of the vehicle. Accordingly, improved dynamometer systems and methods for vehicle testing and evaluation configured to simulate motion in multiple axes are desirable.

### SUMMARY

In various embodiments, systems and methods for testing and evaluation of vehicle dynamics are disclosed. In various embodiments, an exemplary system may comprise a chassis dynamometer. In various embodiments, methods of analyzing vehicle performance with such a chassis dynamometer are disclosed.

In various embodiments, a method for analyzing vehicle performance using a dynamometer comprises is disclosed. The method may comprise vertically supporting a plurality of motorized rollers of the dynamometer. The motorized rollers may each be configured to rotate in a roll direction. The motorized rollers may each be supported on a plurality of motorized rotational mounts of the dynamometer, which may in turn each be configured to rotate in a yaw direction perpendicular to the roll direction. The method may comprise coupling a vehicle under test to the dynamometer such that each tire of the vehicle is vertically supported by a roller of the plurality of rollers.

In various embodiments, the method may further comprise securing the vehicle under test to a restraint system configured to allow lateral, longitudinal, and vertical motion of the vehicle.

In various embodiments, the method may further comprise rotating the plurality of motorized rotational mounts in order to simulate lateral dynamics of the vehicle under test. In various embodiments, the method may further comprise rotating the plurality of motorized rollers in order to simulate longitudinal dynamics of the vehicle under test. In various embodiments, the rotating of the plurality of motorized rotational mounts is concurrent with the rotating of the plurality of motorized rollers.

In various embodiments, the method may further comprise comprising locking an axle of the vehicle in a neutral yaw direction.

In various embodiments, a chassis dynamometer is disclosed. The chassis dynamometer may comprise a roller configured to rotate in a first direction about a roll axis and a turn table supporting the roller and configured to rotate in a second direction about a yaw axis perpendicular to the roll axis.

In various embodiments, the chassis dynamometer may further comprise a direct-drive rotary motor configured to rotate the roller in at least one of a forward or a reverse direction. In various embodiments, the chassis dynamometer may further comprise a second direct-drive rotary motor configured to rotate the turn table in at least one of a right or left direction.

In various embodiments, the turn table includes a base and a platform. In various embodiments, the platform supports the roller and is configured to rotate with respect to the base. In various embodiments, the chassis dynamometer may further comprise a gear train operatively coupling the second direct-drive rotary motor to the platform for operation of the platform.

In various embodiments, the chassis dynamometer may further comprise a controller configured to command rotation of at least one of the direct-drive rotary motor and the second direct-drive rotary motor.

In various embodiments, a dynamometer system is disclosed. The dynamometer system may comprise a plurality of motorized rollers configured for rotation about a first axis. Each roller may be coupled to a motorized rotational mount configured for rotation about a second axis perpendicular to the first axis. In various embodiments, the dynamometer system may comprise a controller. The controller may be operable to command at least one of the plurality of motorized rollers to rotate about the first axis and to command the motorized rotational mount associated with the at least one of the plurality of motorized rollers to rotate about the second axis.

In various embodiments, each motorized rotational mount comprises a direct drive rotary motor. In various embodiments, the rotation of the motorized rotational mount is concurrent with the rotation of the at least one of the plurality of motorized rollers.

In various embodiments, the dynamometer system may further comprise a restraint system for a vehicle under test configured to allow longitudinal motion of the vehicle.

In various embodiments, the restraint system allows vertical motion of the vehicle. In various embodiments, the restraint system allows lateral motion of the vehicle

In various embodiments, the controller is operable in at least one of a first mode for evaluation of longitudinal motion and lateral motion with complete tire and suspension lateral dynamics, a second mode for evaluation of dynamic steering, or a third mode for evaluation of vehicle suspension and vertical dynamics. In various embodiments, the controller is operable and configured to switch between each of the first mode, the second mode, and the third mode.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates an exemplary chassis dynamometer, in accordance with various exemplary embodiments;

FIG. 2A illustrates an exemplary dynamometer system, in accordance with various exemplary embodiments;

FIG. 2B illustrates directional movement of an exemplary chassis dynamometer, in accordance with various exemplary embodiments;

FIG. 2C illustrates a roller surface, in accordance with various exemplary embodiments;

FIG. 2D illustrates a roller surface pattern, in accordance with various exemplary embodiments;

FIGS. 3A, 3B, and 3C illustrates exemplary torques imparted by a dynamometer, in accordance with various exemplary embodiments;

FIG. 4 illustrates an exemplary chassis dynamometer restraint system, in accordance with various exemplary embodiments;

FIG. 5 illustrates an exemplary automation software for a chassis dynamometer, in accordance with various exemplary embodiments;

FIG. 6 illustrates exemplary chassis dynamometer modes, in accordance with various exemplary embodiments;

FIG. 7 illustrates a method of vehicle testing with a chassis dynamometer, in accordance with various exemplary embodiments;

FIG. 8 illustrates a method of vehicle testing with a chassis dynamometer, in accordance with various exemplary embodiments;

FIGS. 9A-9C illustrate a top view, a perspective view, and a side view of a turn table gear tooth profile, in accordance with various embodiments;

FIGS. 10A-10C illustrate a top view, a perspective view, and a side view of a driving gear tooth profile, in accordance with various embodiments; and

FIGS. 11A and 11B illustrate a turn table and frame, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to “singular” includes plural embodiments, and any reference to “more than one” component or step may include a singular embodiment or step. Also, any reference to “attached,” “fixed,” “connected,” or the like may include permanent, removable, temporary, partial, full or any other possible attachment option. Additionally, any reference to “without contact” (or similar phrases) may also include reduced contact or minimal contact. It should also be understood that unless specifically stated otherwise, references to “a,” “an,” or “the” may include one or more than one and that reference to an item in the singular may also include the item in the plural. Further, all ranges may include upper and lower values and all ranges and ratio limits disclosed herein may be combined.

Conventional vehicles rely on human operator input to operate the vehicle. For example, a human operator must turn the steering wheel, thereby turning at least one set of tires of the vehicle via a rack and pinion system. The rotational motion of the steering wheel is translated into linear motion to turn the wheels of the vehicle and change the direction of motion of the vehicle.

However, automated (AV) and connected and automated (CAV) vehicles may rely on either a human operator, an automated drive system (ADS), or a combination of both to operate the vehicle. For example, an ADS of an AV/CAV may send steering commands to control the turning of the wheels and direction of motion of the vehicle without input from a human operator at a steering wheel. Improvements to AV/CAV systems are needed for reliable maneuverability, especially in unique situations such as situations requiring a quick reaction time, sharp turns, or precise turns to avoid obstacles.

Conventional dynamometers are designed to test and evaluate a vehicle in the context of a singular direction of motion. However, testing and evaluation of an AV/CAV's commands to alter a direction of motion requires testing and evaluation of the vehicle in multiple directions of motion.

The present disclosure provides for a dynamometer which can enable both longitudinal and lateral motion. The present dynamometer system also enables lab testing and evaluation of more complex maneuverability and road conditions rather than costly and high-risk real-road testing. The present dynamometer system also enables lab testing and evaluation of clean energy-conversion & energy efficiency of infrastructure-integrated AVs/CAVs, Virtual Reality testing and evaluation of AVs/CAVs in extreme scenarios, and testing and evaluation of AVs/CAVs defense against software and manufacturer violations.

For the sake of brevity, conventional approaches for operation of chassis dynameters and/or the like may not be described in detail herein. Furthermore, the connecting lines shown in various figures contained herein are intended to represent exemplary functional relationships and/or physical or communicative couplings between various elements. It should be noted that many alternative or additional functional relationships or physical or communicative connections may be present in a practical system and/or related methods of use, for example a system for lateral vehicle motion in chassis dynamometer.

In connection with the present disclosure, the term “forward” refers to the direction a driver of the vehicle would be facing when seated or the direction the vehicle would move when in “drive.” “Rear” or “reverse” refers to the direction behind a driver when seated or the direction the vehicle would move when placed in reverse gear. Similarly, “left” and “right” are used herein with respect to the perspective of a driver seated in the driver seat of the vehicle. Further, “driver side” refers the left side of a vehicle and “passenger side” refers to the right side of a vehicle when viewed from the rear of the vehicle. Further, the term “outboard” refers to a direction away from (i.e., outwardly) a center of a vehicle chassis or vehicle, and “inboard” refers to a direction towards (i.e., inwardly) a center of a vehicle chassis or vehicle. The term “yaw” refers to motion about the a vertical axis (i.e. Y axis) while the term “roll” refers to motion about a longitudinal axis (i.e. X axis or R axis).

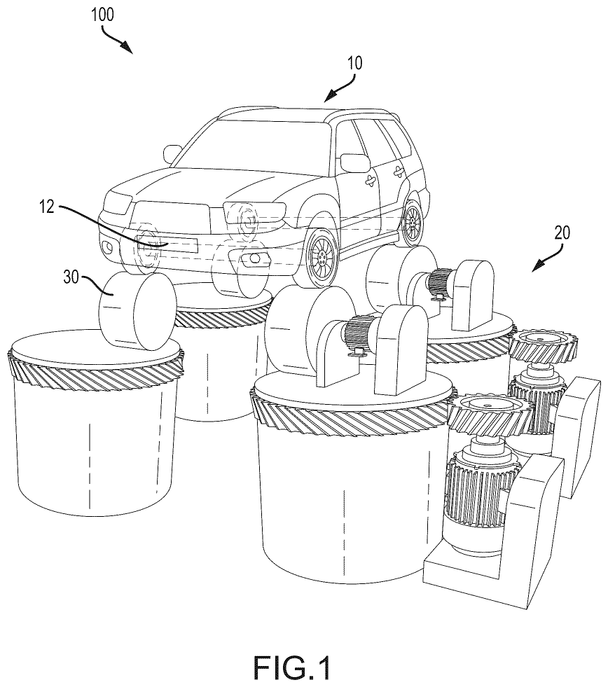

With initial reference to FIG. 1, a chassis dynamometer 100 is illustrated. Chassis dynamometer 100 may be designed to test a vehicle 10, such as an AV/CAV (or any type of wheeled vehicle), and specifically to test the performance of the various vehicle dynamics. In various embodiments, chassis dynamometer 100 may comprise multiple dynamometer systems 20. In various embodiments, chassis dynamometer 100 may comprise multiple non-motorized, or passive, rollers 30. For example, chassis dynamometer 100 may comprise two dynamometer systems 20 correspond to an axle 12 of a vehicle 10 which receives power while two passive rollers 30 correspond to an axle 12 of a vehicle 10 which does not receive power. Alternatively, for example, chassis dynamometer 100 may comprise four dynamometer systems 20 corresponding to two axles 12 of a vehicle 10. Alternatively, for example, chassis dynamometer 100 may comprise one dynamometer system 20 corresponding to an axle 12 of a vehicle 10 which receives power while the alternative side of the axle 12 corresponds to a passive roller 30. Alternatively, for example, chassis dynamometer 100 may comprise two dynamometer systems 20 corresponding to two axles 12 of a vehicle 10 while the alternative sides of each axle 12 correspond to passive rollers 30. Chassis dynamometer 100 may comprise any number of dynamometer systems 20 and any number of passive rollers 30.

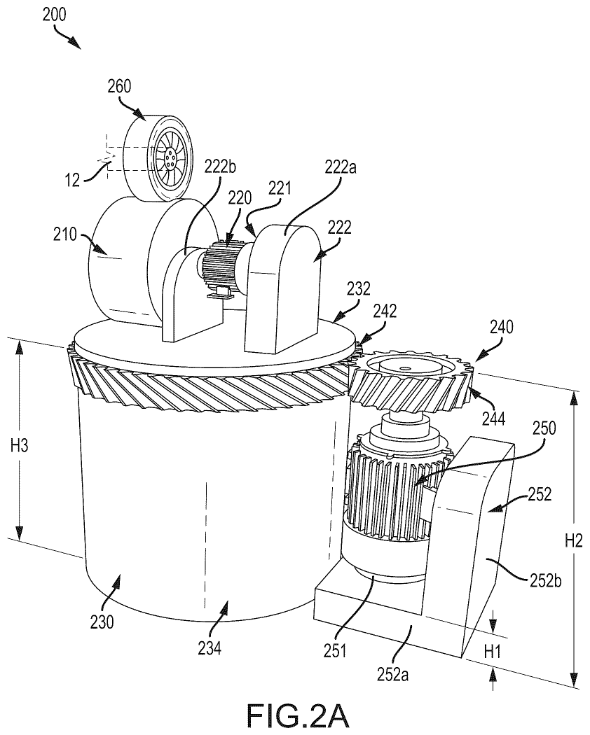

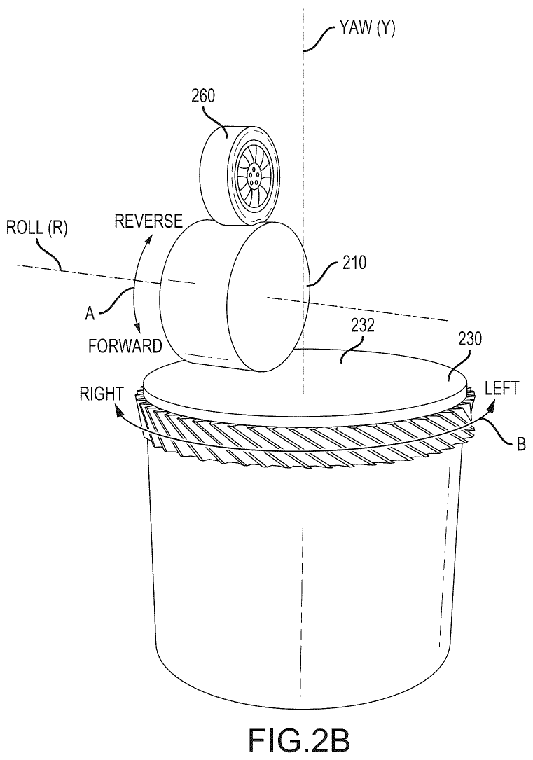

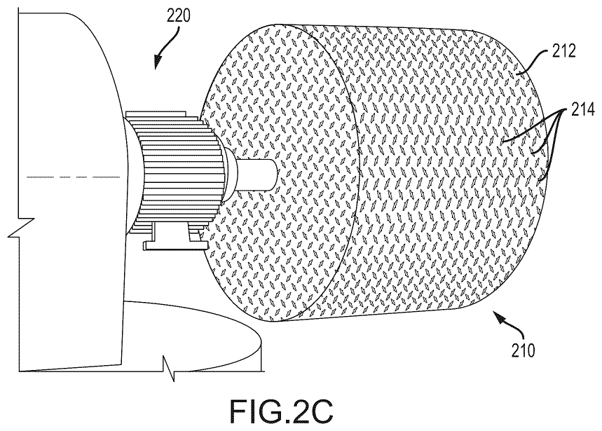

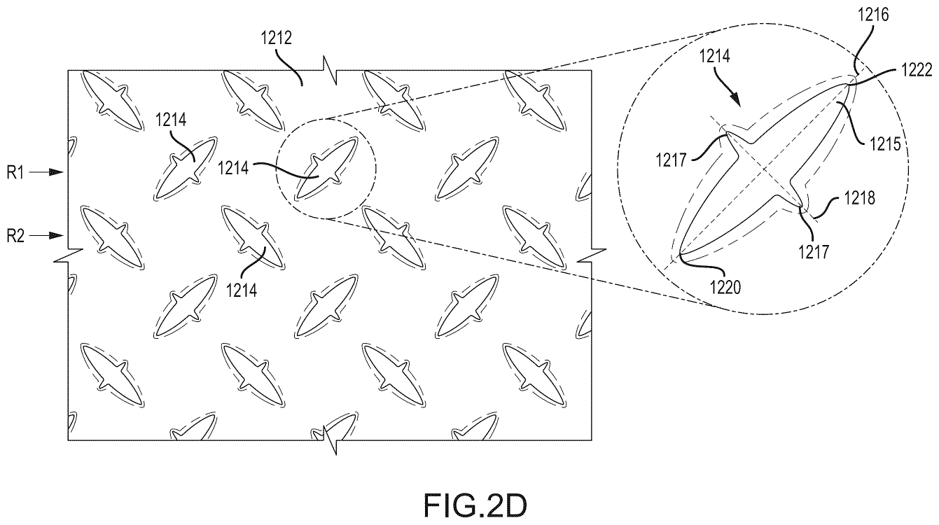

With initial reference to FIG. 2, a dynamometer system 200 is illustrated, in accordance with various embodiments. Dynamometer system 200 may be similar to dynamometer systems 20 of FIG. 1. The dynamometer system 200 may comprise a roller 210 and a roller motor 220, which is configured to rotate roller 210. In various embodiments, the roller motor 220 may be configured to convert rotational motion of roller 210 to an electric signal. The roller motor 220 may be mounted to a turn table 230 (also referred to herein as a rotational mount or a motorized rotational mount) via a roller motor mount 222. The roller motor mount 222 may comprise a first portion 222a coupling a first end of the roller motor 220 to the turn table 230. The roller mount 222 may comprise a second portion 222b coupling a second end opposite the first end of the roller motor 220 to the turn table 230. The first portion 222a may extend from the turn table 230 vertically above the roller motor 220. The first portion 222a may provide support to a backside 221 of the roller motor 220. The first portion 222a may support the weight of roller motor 220. The second portion 222b may provide support to the rotating shaft of the roller motor 220. The second portion 222b may provide a shield to protect the roller motor 220 from, for example, debris from rotation of the rollers and/or the test vehicle. The turn table 230 may be a motorized rotational mount configured to support the roller 210. In various embodiments, roller 210 is configured to rotate about a roll axis R with respect to the turn table 230. The roller motor 220 may be mounted to a rotating platform 232 of turn table 230. Turn table 230 may also comprise a table base 234. In various embodiments, rotating platform 232 may be configured to rotate about a yaw axis Y. In various embodiments, roller motors 220 are high accuracy direct-drive rotary motors providing precise motion control.

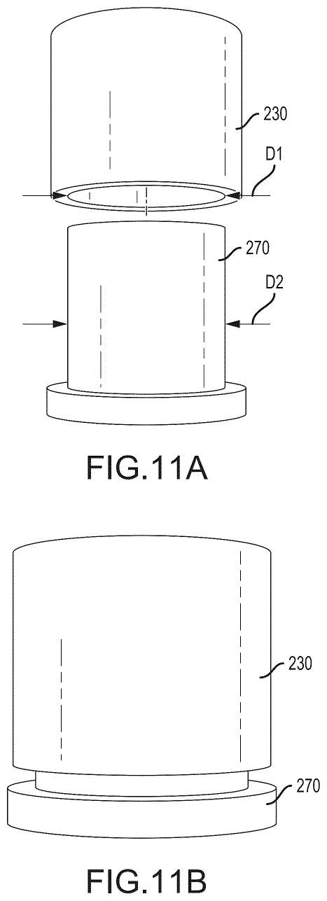

In various embodiments and with additional reference to FIGS. 11A and 11B, the turn table 230 comprises an underlying frame 270. The frame 270 is disposed beneath the turn table 230 and configured to support the rotation of the rotating platform 232. With additional reference to FIG. 2E, the turn table 230 may be cylindrical. Turn table 230 may be hollow with an internal diameter D1. The frame 270 may be cylindrical and have an outer diameter of D2. D2 may be less than D1 such that the turn table 230 is freely rotatable about the frame 270.

In various embodiments, dynamometer system 200 further comprises a gear train 240. Gear train 240 may comprise any number of gears. In various embodiments, gear train 240 may comprise a turn table gear 242 and a driving gear 244. In various embodiments, turn table gear 242 and driving gear 244 may be in direct contact with each other, as shown in FIG. 2. In various embodiments, gear train 240 may comprise multiple gears or connections mechanically coupling turn table gear 242 and driving gear 244, which are not necessarily directly coupled. In various embodiments, turn table gear 242 is configured to rotate the rotating platform 232 of the turn table 230 with respect to the table base 234.

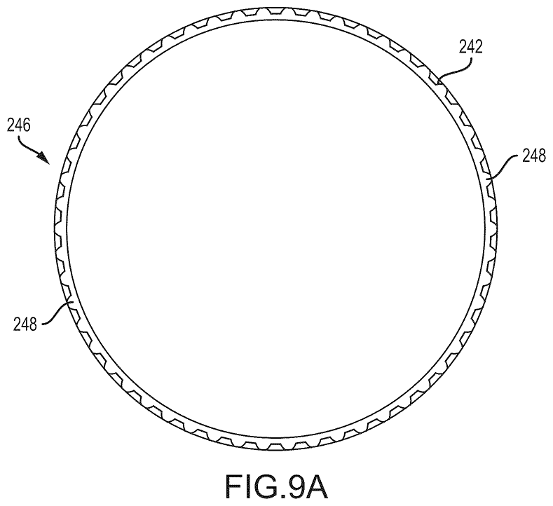

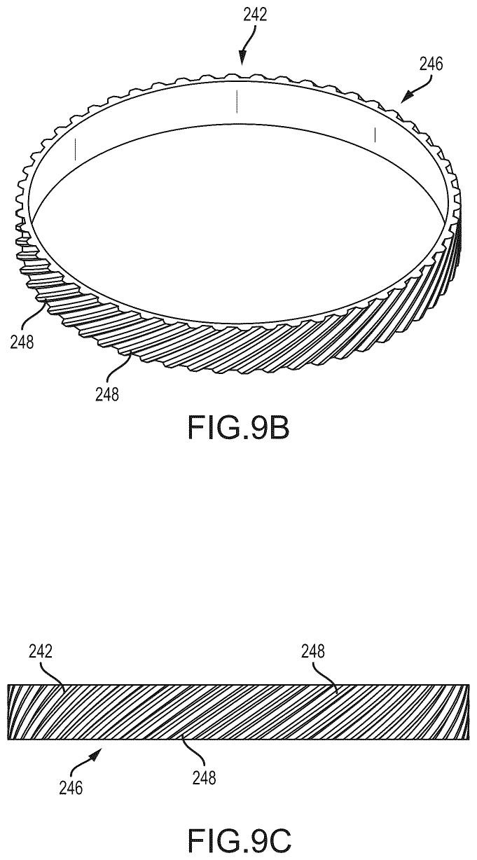

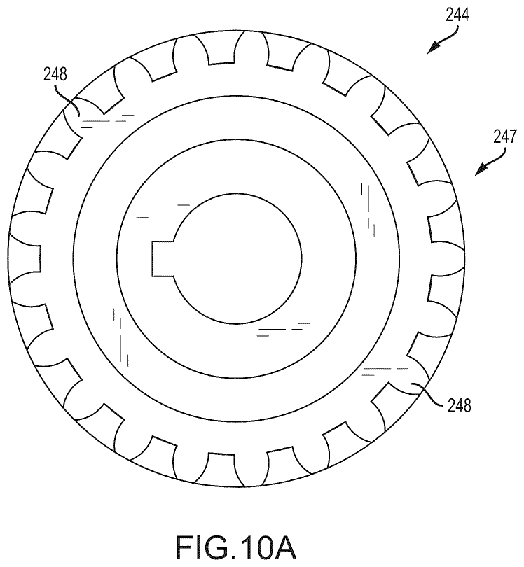

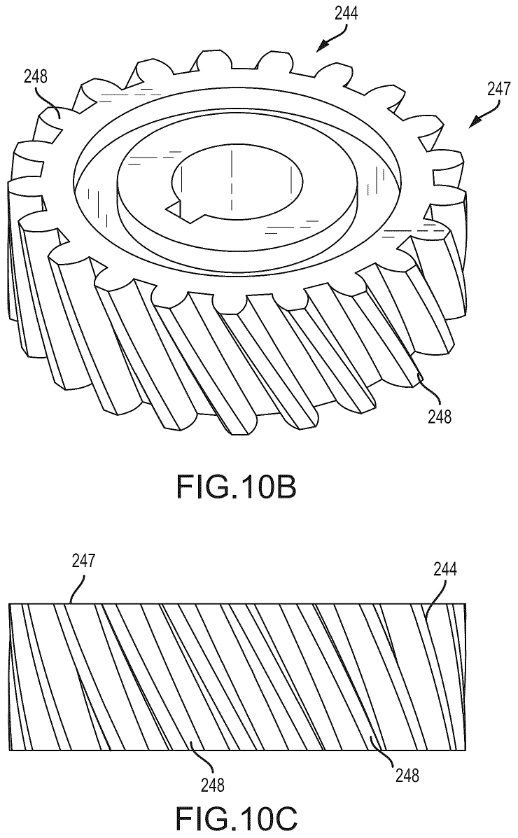

With reference to FIGS. 9A-C and FIGS. 10A-C, and in various embodiments, each of the turn table gear 242 and a driving gear 244 is configured with a particular tooth profile. Turn table gear 242 may have a first tooth profile 246. Driving gear 242 may have a second tooth profile 247. In various embodiments, each of the first tooth profile 246 and the second tooth profile 247 may comprise a plurality of elongated faces 248 oriented diagonally with respect to the yaw axis Y. The tooth profiles 246, 247 may have complementary elongated faces 248 such that the turn table gear 242 and the driving gear 244 are intermeshing gears.

In various embodiments, dynamometer system 200 further comprises a turn table motor 250. In various embodiments, turn table motor 250 is secured to a surface via a turn table motor mount 252. In various embodiments, the turn table mount 252 may be an L-shaped mount having a horizontal portion 252a and a vertical portion 252b. The horizontal portion 252a may be coupled to a backside 251 of turn table motor 250. The horizontal portion 252a may be disposed beneath turn table motor 250 with a height H1 corresponding to the location of the gear train 240. In other words, the horizontal portion 252a is dimensioned to locate the height H2 from ground of the driving gear 244 at the same height H3 from ground as the turn table gear 242. In various embodiments, the vertical portion 252b may be coupled to a circumference of the turn table motor 250. The vertical portion 252b may be disposed radially outward with respect to the turn table motor 250 from the turn table 230. In other words, the turn table motor 250 may be disposed between the turn table 230 and the turn table motor 250. In various embodiments, the turn table motors 250 are high accuracy direct-drive rotary motors providing precise motion control.

With reference to FIGS. 2A and 2B, dynamometer system 200 may be configured to measure force, torque, power, or combination thereof of a vehicle engine by measuring output at a wheel 260 (or at each wheel 260 or various combinations of wheels 260). In various embodiments, roller 210 is configured to rotate in a first (or roll) direction A in response to force applied from a wheel 260. In various embodiments, rotation of roller 210 applies a force to motor 220 which may convert the rotational energy from roller 210 to an electric signal for determining force, torque, or power of a vehicle drive system. In various embodiments, roller 210 applies a counter force to wheel 260 in an opposite roll direction-A to simulate road conditions. In various embodiments, roller motor 220 is configured to rotate roller 210 in the opposite roll direction-A in order to rotate wheel 260 in the roll direction A.

With reference to FIG. 2C and in various embodiments, roller 210 may comprise a surface pattern 212. The surface pattern 212 may be configured to provide a rough contact surface. The surface pattern 212 may define a diamond plate pattern defined by elongated protrusions 214. The protrusions 214 may be disposed in rows. Alternating rows may comprise protrusions 214 of alternating directions. The protrusions 214 of a first row R1 may be angled in a first direction. The protrusions 214 of a second row R2, adjacent to the first row R1, may be oriented between 65° and 105° degrees with respect to the protrusions 214 of the first row R1. The protrusions 214 of the second row R2 may be oriented between 85° and 95° degrees with respect to the protrusions 214 of the first row R1. The protrusions 214 of the second row R2 may be oriented approximately 90° degrees with respect to the protrusions 214 of the first row R1. In various embodiments, the surface pattern 212 of alternating first rows RI and second rows R2 is continuous along a circumference of the roller 210.

The surface pattern 212 is configured to mimic road surfaces in various conditions such as, but not limited to, rain, snow, or slick conditions. The roller 210 may have a length of between 10 and 48 inches. The roller 210 may have a length of between 13 and 42 inches. The roller 210 may have a length of between 20 and 36 inches. The roller 210 may have a diameter of between 36 and 72 inches. The roller 210 may have a diameter of between 42 and 66 inches. The roller 210 may have a diameter of between 48 and 60 inches. In this manner, the roller 210 provides a contact surface configured to provide sufficient contact in the event the test vehicle 10 experiences a tire lock while under testing conditions. For example, were a tire corresponding to a particular roller 210 to lock while the roller 210 provides a steering angle by rotating around the yaw axis Y, the roller 210 would maintain contact with the tire of the test vehicle 10.

With additional reference to FIG. 2D, a surface pattern 1212 is illustrated. Surface pattern 1212 may be similar to surface pattern 212. Surface pattern 1212 may be an exemplary embodiment of surface pattern 212. Each elongated protrusion 1214 of surface pattern 1212 may be defined by a first elongated shape 1215 extending along a first axis 1216. The first elongated shape 1215 may be an elliptical shape. The first elongated shape 1215 may be an elliptical shape with narrowed vertices. Each elongated protrusion 1214 of surface pattern 1212 may be defined by a pair of pointed shapes 1217 extending from the minor axis 1218 of each first elongated shape 1214.

In various embodiments, the patterned protrusions 1214 extending from a first point 1220 to a second point 1222. Each first point 1220 of the protrusions 1214 of the first row R1 is disposed at a midpoint between two second points 1222 of the protrusions 1214 of the second row R2. (It will be understood that each of the first row RI and the second row R2 must have a first and last protrusion 214 that is not between two others. However, the first and last protrusion 214 of each row will be located at a point which would be a midpoint were the pattern to be infinite.)

With continued reference to FIGS. 2A and 2B and in various embodiments, turn table motor 250 is configured to rotate rotating platform 232 (via gear train 240) in a second (or yaw) direction B. In various embodiments, roll direction A may correspond to the rotation of wheel (or tire) 260 about axle 12. In various embodiments, yaw direction B may be perpendicular to roll direction A and may correspond to changing the direction the wheel 260 faces. In other words, changing a direction of wheels 260, or roller 210, within roll direction A may correspond to changing a direction of motion of vehicle 10 between forward and reverse while changing a direction of wheels 260, or rotating platform 232 within yaw direction B may correspond to changing the direction of motion of vehicle 10 between left and right as perceived by an occupant of the vehicle.

In various embodiments, roller motor 220 may be disposed coaxially with roller 210. In various embodiments, roller motor 220 may be offset from the axis of roller 210 and drive roller 210 via a gear train (not shown). In various embodiments, turn table motor 250 may be disposed coaxially with turn table 230 (not shown). In various embodiments, turn table motor 250 may be offset from the axis of turn table 230 and drive turn table 230 via a gear train.

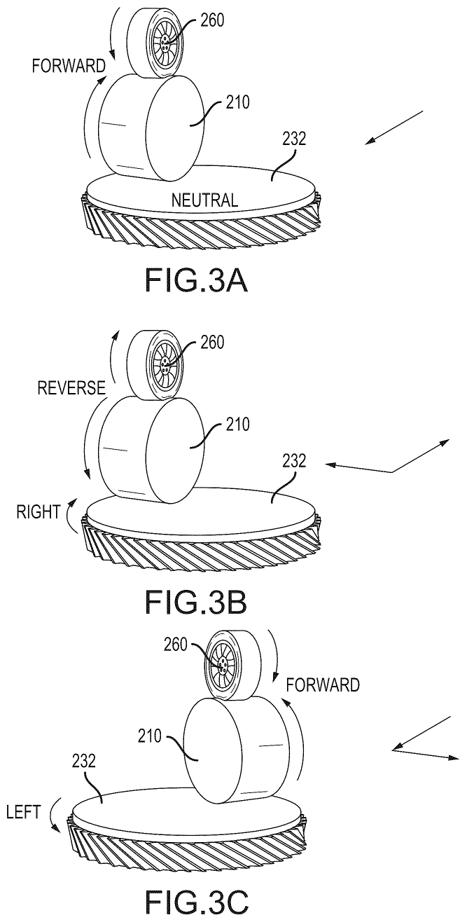

With reference to FIGS. 3A-3C, various orientations of rollers 210 and rotating platform 232 are illustrated. In various embodiments, orientation of rollers 210 and rotating platform 232 correspond to various forces imparted on the tested vehicle 10 (and the vehicle engine). In other words, roller motor 220 and turn table motor 250 impart various forces on the tested vehicle 10. In various embodiments, and as depicted in FIGS. 3A and 3C, when roller 210 is rotated in reverse about roll axis R, a forward rotational force is applied to wheel 260. As a result, a force is imparted on vehicle in a forward longitudinal direction. In various embodiments, and as depicted in FIG. 3B, when roller 210 is rotated forward about roll axis R, a reverse rotational force is applied to wheel 260. As a result, a force is imparted on vehicle in a reverse longitudinal direction. In various embodiments, roller 210 may also be in a neutral position, without rotational movement about roll axis R; in this case, wheel 260 would remain in a neutral position with respect to the longitudinal direction.

In various embodiments, turn table motor 250 imparts a force on rotating platform 232 to cause rotation of rotating platform 232 about yaw axis Y. In various embodiments, and as depicted in FIG. 3A, when rotating platform 232 is in a neutral position about yaw axis Y, wheel 260 is also in a neutral position with respect to a lateral direction. In various embodiments, and as depicted in FIG. 3B, when rotating platform 232 is rotated clockwise about yaw axis Y, wheel 260 is turned to the right. (It is understood that “turned to the right/left” is how a driver of vehicle 10 would perceive the motion. It is also understood that the chassis dynamometer 100 could be oriented differently with respect to vehicle 10 such that counterclockwise rotation causes a “turned right” motion as would be perceived by a driver.) As a result, a force is imparted on vehicle in a right lateral direction. In various embodiments, and as depicted in FIG. 3C, when rotating platform 232 is rotated counterclockwise about yaw axis Y, wheel 260 is turned to the left. As a result, a force is imparted on vehicle in a left lateral direction.

In various embodiments, the chassis dynamometer 100 may be dimensioned with an instantaneous center of gravity 280 at a predetermined point such that the chassis dynamometer 100 imparts a particular set of intended forces on the test vehicle 10. In various embodiments, any particular dynamometer system 200 may be dimensioned with an instantaneous center of gravity 280 at a predetermined point such that the dynamometer system 200 imparts a particular set of intended forces on the test vehicle 10. The dynamometer system 200 may be dimensioned with an instantaneous center of gravity 280 at a predetermined point by adjusting a longitudinal position of the roller 210 and/or by adjusting a lateral position of the roller 210.

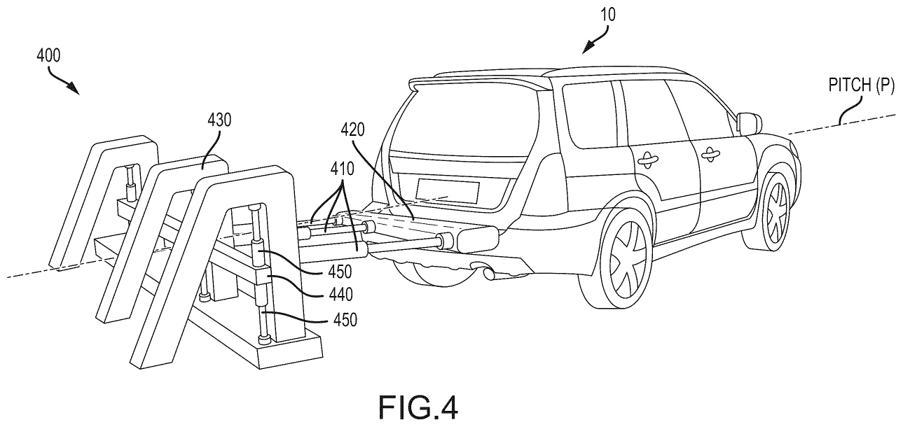

In various embodiments, and with reference to FIG. 4, a restraint system 400 is illustrated. In various embodiments restraint system 400 is designed to restrain vehicle 10 in a manner consistent with testing and evaluation of chassis dynamometer 100. In various embodiments, restraint system 400 is configured to impart a torque to the text vehicle 10 about a pitch axis (P). Conventional strap-type restraint systems exert horizontal forces in the lateral and/or longitudinal directions as well as vertical forces on the vehicle. Conventional systems would obstruct the evaluation and performance of the chassis dynamometer 100 disclosed herein due to lateral restriction as the present disclosure provides for both longitudinal and lateral movement.

In various embodiments, restraint system 400 comprises a main frame chassis 420 which is configured to couple to a rear of the main frame of a vehicle 10. In various embodiments, restraint system 400 comprises hydraulic actuators 410 which couple to the main fame chassis 420. In various embodiments, hydraulic actuators 410 are slidably coupled to a lateral bar 440 spanning fixed base 430 and extending beyond a width of the main frame of vehicle 10. In this manner, restraint system 400 may allow for horizontal movement of hydraulic actuators 410 with respect to fixed base 430. Lateral bar 440 may be slidably coupled to fixed base 430. In this manner, restraint system 400 may allow for vertical movement of hydraulic actuators 410 with respect to a fixed base 430.

In various embodiments, restraint system 400 comprises hydraulic actuators 450, which may be similar to hydraulic actuators 410 but cause actuation (or movement) in a direction perpendicular to that of hydraulic actuators 410. In various embodiments, restraint system 400 comprises hydraulic actuators 410, 450 which allow for testing of the vehicle's 10 reaction to both longitudinal and lateral forces.

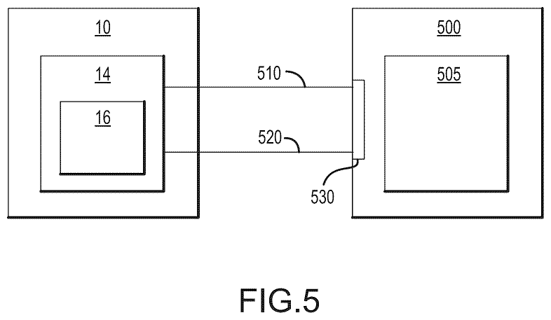

In various embodiments, and with reference to FIG. 5, chassis dynamometer 100 may comprise a controller 500 in electrical communication with at least one of, or both of, the roller motor 220 and the turn table motor 250. In various embodiments, controller 500 may be used as a central network element or hub to access various system and components of the chassis dynamometer 100 system. Controller 500 may comprise a network, computer-based system, and/or software components configured to provide an access point to various systems and components of chassis dynamometer 100. In various embodiments, controller 500 may comprise a processor. In various embodiments, controller 500 may be implemented in a single processor. In various embodiments, controller 500 may be implemented as and may include one or more processors and/or one or more tangible, non-transitory memories and be capable of implementing logic. Each processor can be a general-purpose processor, a digital signal processor (DSP), an application specific integrated circuit (ASIC), a field programmable gate array (FPGA) or other programmable logic device, discrete gate or transistor logic, discrete hardware components, or any combination thereof. Controller 500 may comprise a processor configured to implement various logical operations in response to execution of instructions, for example, instructions stored on a non-transitory, tangible, computer-readable medium configured to communicate with controller 500.

System program instructions and/or controller instructions may be loaded onto a non-transitory, tangible computer-readable medium having instructions stored thereon that, in response to execution by a controller, cause the controller to perform various operations. The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

In various embodiments, chassis dynamometer 100 comprises automation software 505 may receive acceleration commands 510 (i.e. signals) from vehicle 10. In various embodiments, automation software 505 may receive from steering commands 520 (i.e. signals) vehicle 10. In various embodiments, automation software 505 may receive acceleration commands 510 and steering commands 520 from an Automated Drive System (ADS) 14 of vehicle 10. In various embodiments, chassis dynamometer 100 receives acceleration commands 510 and steering commands 520 via a Controller Area Network (CAN) bus interface 530 operably coupled to controller 500. As a result, chassis dynamometer 100 may be controlled by ADS 14 commands 510, 520. In various embodiments, as ADS 14 sends acceleration commands 520 and wheels 260 rotate, rollers 210 simulate an infinite road. Similarly, and in various embodiments, as ADS 14 sends steering commands 520 and wheels 260 turn, rotating table 232 simulates a non-linear road.

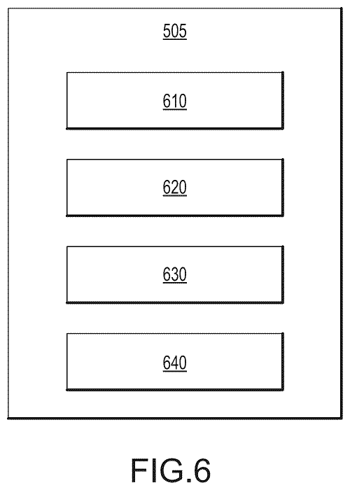

In various embodiments, and with reference to FIG. 6, automation software 505 of chassis dynamometer 100 may operate in a first mode 610. First mode 610 may provide for evaluation of longitudinal motion and lateral motion with complete tire and suspension lateral dynamics. In various embodiments, in first mode 610, the axle 12 of wheel 560 may be locked in a neutral yaw direction. In various embodiments, in first mode 610, steering commands 520 from the ADS 14 may be input to turn table motor 250. Turn table motor 250 may then rotate rotating platform 232 to simulate lateral dynamics of the vehicle 10. In various embodiments, lateral dynamics, corresponding engine performance, and the ADS's response to lateral dynamics of vehicle 10 under such conditions may be measured and evaluated.

In various embodiments, and with reference to FIG. 6, chassis dynamometer 100 may operate in a second mode 620. Second mode 620 may provide for evaluation of dynamic steering. Second mode 620 may provide for synchronized motion of both rollers 210 and rotating platform 232. In various embodiments, in second mode 620, vehicle 10 may control the steering of wheels 260. In various embodiments, in second mode 620, turn table motor 250 does not impart force on rotating platform 232.

In various embodiments, and with reference to FIG. 6, chassis dynamometer 100 may operate in a third mode 630. Third mode 630 may provide for evaluation of vehicle suspension and vertical dynamics. In various embodiments, restraint system 400 may provide for evaluation of vehicle suspension and vertical dynamics.

In various embodiments, and with reference to FIG. 6, chassis dynamometer 100 may operate in a fourth mode 640. Fourth mode 640 may provide for evaluation of isolated longitudinal motion capability. In various embodiments, in fourth mode 40, rotating platform 232 is locked and does not rotate.

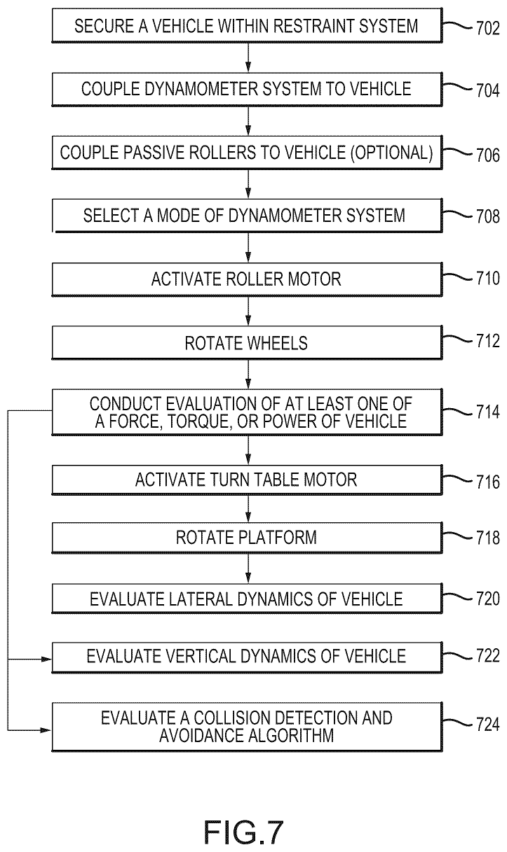

With reference to FIG. 7, a method of vehicle evaluation 700 is provided in accordance with various embodiments. In various embodiments, method of vehicle evaluation 700 may include step 702, securing a vehicle 10 within restraint system 400. In various embodiments, method of vehicle evaluation 700 may include step 704, coupling at least one dynamometer system 200 to vehicle 10. In various embodiments, method of vehicle evaluation 700 may include step 706, disposing passive rollers 30 at any wheel 260 not coupled to a dynamometer system 200. In various embodiments, method of vehicle evaluation 700 may include step 708, selecting a mode of dynamometer system 200 to be at least one of first mode 610, second mode 620, third mode 630, or fourth mode 640.

In various embodiments, method of vehicle evaluation 700 includes step 710, activating roller motor 220 in response to or to cause rotation of roller 210. In various embodiments, method of vehicle evaluation 700 may include step 712, rotating wheels 560 in response to or to cause rotation of roller 210. In various embodiments, method of vehicle evaluation 700 may include step 714, evaluating at least one of a force, torque, or power of vehicle 10 based on rotation of roller 210.

In various embodiments, method of vehicle evaluation 700 may include step 716, activating turn table motor 250 in response to or to cause rotation of rotating platform 232. In various embodiments, method of vehicle evaluation 700 may include step 718, turning wheels 260 in response to or to cause rotation of rotating platform 232. In various embodiments, method of vehicle evaluation 700 may include step 720, evaluating lateral dynamics of vehicle 10 based on rotation of rotating platform 232.

In various embodiments, steps 714 and 720 may be performed separately, at concurrent times. In various embodiments, steps 714 and 720 may be performed simultaneously.

In various embodiments, method of vehicle evaluation 700 may include step 722, evaluating vertical dynamics of vehicle 10 in response to performing at least one of step 710 or 716.

In various embodiments and with additional reference to FIG. 5, method of vehicle evaluation 700 may include step 724, evaluating a collision detection and avoidance algorithm 16 of ADS 14.

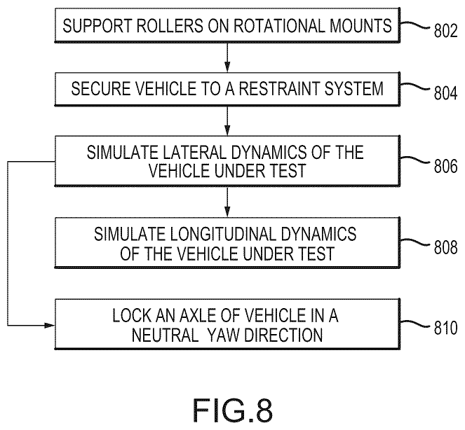

In various embodiments and with reference to FIG. 8, a method 800 for analyzing vehicle performance using a dynamometer is provided in accordance with various embodiments. The method 800 may include step 802, vertically supporting a plurality of motorized rollers 210 on a plurality of motorized rotational mounts such as turn tables 230. In various embodiments, the rollers 210 may be configured to rotate in a roll direction R. In various embodiments, the motorized rotational mounts 230 may be configured to rotate in a yaw direction Y perpendicular to the roll direction R. In various embodiments, method 800 may include step 804, securing the vehicle under test 10 to a restraint system 400 configured to allow lateral, longitudinal, and vertical motion of the vehicle 10.

In various embodiments, method 800 may include step 806, rotating the plurality of motorized rotational mounts 230 in order to simulate lateral dynamics of the vehicle under test 10. In various embodiments, method 800 may include step 808, rotating the plurality of motorized rollers 210 in order to simulate longitudinal dynamics of the vehicle under test 10. In various embodiments, step 808 may include rotation of the plurality of motorized rotational mounts 230 concurrent with rotation on of the plurality of motorized rollers 210. In various embodiments, method 800 may include step 810, locking an axle 12 of the vehicle 10 in a neutral yaw direction.

Finally, it should be noted that while this disclosure is directed primarily to testing and evaluation of a vehicle performance while simulating real-world conditions, that the concepts described above can also be applied to performing vehicle maintenance, testing under alternative conditions, emissions testing, testing of isolated components, etc. For example, system 100 can be used to perform emissions testing, noise and vibration testing, or performance in a climactic environmental chamber.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” or “at least one of A, B, and C” is used in the specification or claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching may be used throughout the figures to denote different parts but not necessarily to denote the same or different materials.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above-described concepts can be used alone or in combination with any or all of the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. A method for analyzing vehicle performance using a dynamometer comprising:
vertically supporting a plurality of motorized rollers of the dynamometer, each configured to rotate in a roll direction, on a plurality of motorized rotational mounts of the dynamometer, each configured to rotate in a yaw direction perpendicular to the roll direction; and
coupling a test vehicle to the dynamometer such that each tire of the test vehicle is vertically supported by a roller of the plurality of rollers.

2. The method of claim 1, further comprising securing the test vehicle to a restraint system configured to allow lateral, longitudinal, and vertical motion of the test vehicle.

3. The method of claim 2, further comprising rotating the plurality of motorized rotational mounts in order to simulate lateral dynamics of the test vehicle.

4. The method of claim 3, further comprising rotating the plurality of motorized rollers in order to simulate longitudinal dynamics of the vehicle under test, wherein the rotating of the plurality of motorized rotational mounts is concurrent with the rotating of the plurality of motorized rollers.

5. The method of claim 3, further comprising locking an axle of the test vehicle in a neutral yaw direction.

6. The method of claim 3, further comprising:
operating the plurality of motorized rollers in a first operational configuration configured to achieve an instantaneous center of gravity in a first predetermined location; and
operating the plurality of motorized rollers in a second operational configuration configured to achieve a second instantaneous center of gravity in a second predetermined location.

7. A chassis dynamometer comprising:
a roller configured to rotate in a first direction about a roll axis; and
a turn table supporting the roller and configured to rotate in a second direction about a yaw axis perpendicular to the roll axis, the turn table having a base and a platform, the platform supporting the roller and configured to rotate with respect to the base.

8. The chassis dynamometer of claim 7, further comprising a gear train operatively coupled to the turn table, the gear train including a first gear with a first tooth profile and a second gear with a second tooth profile.

9. The chassis dynamometer of claim 8, wherein each of the first tooth profile and the second tooth profile is defined by elongated faces oriented diagonally with respect to the yaw axis.

10. The chassis dynamometer of claim 8, further comprising a first direct-drive rotary motor operatively coupled to the turn table via the gear train and configured to rotate the turn table in at least one of a right or left direction, the first direct-drive rotary motor supported on a first end by a horizontal portion of a second motor mount and supported by a vertical portion of the second motor mount coupled to a circumference of the second direct-drive rotary motor.

11. The chassis dynamometer of claim 10, further comprising a second direct-drive rotary motor configured to rotate the roller in at least one of a forward or a reverse direction, wherein the second direct-drive rotary motor is supported on a first end by a first portion of a motor mount and supported on a second end by a second portion of the motor mount.

12. The chassis dynamometer of claim 7, wherein the roller has a surface pattern defined by a plurality of protrusions arranged in a pattern about the circumference of the roller.

13. A dynamometer system, comprising:
a plurality of motorized rollers configured for rotation about a first axis, each roller coupled to a motorized rotational mount configured for rotation about a second axis perpendicular to the first axis; and
a controller operable to:
command at least one of the plurality of motorized rollers to rotate about the first axis, and
command the motorized rotational mount associated with the at least one of the plurality of motorized rollers to rotate about the second axis, such that the rotation of the plurality of motorized rollers imparts an instantaneous center of gravity at a first predefined location.

14. The system of claim 13, wherein each motorized rotational mount comprises a direct drive rotary motor.

15. The system of claim 14, wherein the rotation of the motorized rotational mount is concurrent with the rotation of the at least one of the plurality of motorized rollers.

16. The system of claim 15, further comprising a restraint system for a vehicle under test configured to allow longitudinal motion of the vehicle configured to allow vertical motion of the vehicle and lateral motion of the vehicle.

17. The system of claim 13, wherein the motorized rotation mount is commanded to rotate such that the rotation of the plurality of motorized rollers imparts an instantaneous center of gravity at a first predefined location.

18. The system of claim 13, TBD, wherein each of the first tooth profile and the second tooth profile is defined by elongated faces oriented diagonally with respect to the yaw axis.

19. The system of claim 13, wherein the controller is operable in at least one of a first mode for evaluation of longitudinal motion and lateral motion with complete tire and suspension lateral dynamics, a second mode for evaluation of dynamic steering, or a third mode for evaluation of vehicle suspension and vertical dynamics.

20. The system of claim 19, wherein the controller is operable and configured to switch between each of the first mode, the second mode, and the third mode.
